(19) United States
(12) Patent Application Publication
(10) Pub. No.: US 2023/0269073 A1
(43) Pub. Date: Aug. 24, 2023

(54) The Generation Of One Way Functions, Based On Mutual Hiding Predefined Success Criteria

(71) Applicant: B.G. Negev Technologies and Applications Ltd., at Ben-Gurion University, Beer Sheva (IL)

(72) Inventors: Shlomi Dolev, Omer (IL); Hagar Dolev, Omer (IL)

(73) Assignee: B.G. Negev Technologies and Applications Ltd., at Ben-Gurion University, Beer Sheva (IL)

(21) Appl. No.: 18/014,107

(22) PCT Filed: Jul. 1, 2021
(86) PCT No.: PCT/IL2021/050819

§ 371 Date: Dec. 30, 2022

Related U.S. Application Data
(60) Provisional application No. 63/047,277, filed on Jul. 2, 2020.

(51) Int. Cl. H04L 9/06

(52) U.S. Cl. CPC H04L 9/0643; H04L 9/0618

(57) ABSTRACT

A method for creating a one-way function from a computation problem instances with a predefined success criteria, based on mutual hiding of the success criteria, comprising the steps of selecting at least a first and a second original computation tasks, each having an original corresponding success criterion; applying a function (such as a bitwise XOR operation) over both original corresponding success criteria, to form a single combined success criterion for a mutual computation task being a combination of the at least a first and a second original computation tasks; outputting the original computation tasks along with the combined success criterion, while excluding the original corresponding success criteria.

### FIELD OF THE INVENTION

The present invention relates to the field of cryptography. More particularly, the invention relates to a method for the generation of one-way functions, based on mutual hiding of predefined success criteria.

### BACKGROUND OF THE INVENTION

One-way functions play an important role in modern cryptography and are used, for example, to generate symmetric ciphers, which use the same cryptographic keys for both encryption of plaintext and decryption of ciphertext. However, until now, there is no provable one-way function, and the current functions that are used in practice as one-way functions are assumed to be one-way functions, rather than being proven one-way functions. As a result, assumed one-way functions sometimes later reveal weaknesses, as described for example, in [10].

There is a class of computational problems, which is called Nondeterministic Polynomial-time (NP) and a sub-class of NP called NP-complete (in computational complexity theory, a problem is NP-complete when a brute-force search algorithm can solve it, and the correctness of each solution can be verified quickly, and the problem can be used to simulate any other problem with similar solvability).

The existence of a provable one-way function, such as a cryptographic hash function, is a longstanding open problem. One-way functions are functions of the shape f:x → f(x), such that they are easy to compute, but are very hard to “decipher”. This means that given a random image of f(x), it will be very hard to compute x. In this context, easy computation means that the one-way functions have a polynomial-time p Turing Machine (a Turing Machine is a simple abstract computational device intended to investigate the extent and limitations of what can be computed). In this case, given an input x, a Turing Machine is able to compute f(x) in polynomial time p (an algorithm is considered to be solvable in polynomial time if the number of steps required to complete the algorithm for a given input is O(n^{k}) for some nonnegative integer k, where n is the length of the input. Polynomial-time algorithms are considered to be relatively “fast”). Most familiar mathematical operations such as addition, subtraction, multiplication, and division, as well as computing square roots, powers, and logarithms, can be performed in polynomial time.

Similarly, hard computation means that given a random f(x), it is impossible to compute x within the same polynomial-time p.

It is therefore an object of the present invention to provide a method for increasing the cryptographic strength of one-way functions using several instances of one-way functions and mutually encode their results.

It is another object of the present invention to provide a method for using random polynomials and ordering points of the polynomial as a primitive for one way function.

It is a further object of the present invention to provide a method for randomly creating an array of sorted integers and randomly shuffle the entries of the array inΘ(n) operations, which in turn require Θ(nlogn) comparison operations to resort the array.

Other objects and advantages of the invention will become apparent as the description proceeds.

### SUMMARY OF THE INVENTION

A method for creating a one-way function from a computation problem instances with a predefined success criteria, based on mutual hiding of the success criteria, comprising the steps of:
a) selecting at least a first and a second original computation tasks, each having an original corresponding success criterion;
b) applying a function (such as a bitwise XOR operation) over both original corresponding success criteria, to form a single combined success criterion for a mutual computation task being a combination of the at least a first and a second original computation tasks; and
c) outputting the original computation tasks along with the combined success criterion, while excluding the original corresponding success criteria.

The computation task may be defined by elements in an array representing a polynomial having randomly selected coefficients. The predefined success criteria may be the free coefficient of the polynomial. The computation task may consist of the success criteria and the randomly shuffled elements of the array.

The predefined success criteria may be a subset-sum of each array of elements.

The method may also, comprise the steps of:
a) creating a sorted array of n distinct elements;
b) representing the elements of the sorted array by values of a polynomial p of degree n - 1, where the x of a value in the sorted array is the index of each element and the y is the actual value of the each element, wherein the coefficients of the polynomial are randomly chosen;
c) generating a plurality of randomized permutations of the sorted array by:
   c.1) swapping the first element in the sorted array with itself or with any other element;
   c.2) swapping the second element in the obtained array with any other element in the obtained array with an element residing in the range starting with the second element and ending with the last element;
   c.3) repeating the preceding step, until considering the element currently residing in the array and having an index being one prior to the last index, for swapping with itself, or with the element currently having the very last index; and
   c.4) presenting the shuffled array as a sorting computation task.

Permutations may be the result of shuffling the sorted array using Fisher-Yates shuffle, by:
a) considering each entry is as in Fisher-Yates shuffle, when dealing with the i′th item and receiving a random index j of log n of the size of the random bits of the array;
b) examining whether j < i and if j < i, discarding the random index j and receiving another index j′, until j′ is greater than i - 1;
c) performing a swap and incrementing the index i is by 1; and
d) repeating the preceding steps until i = n - 1.

The sorted array of n elements may be created using random incremental additions from element i to the i+1 element, in Θ(n) operations, then randomly shuffled in Θ(n) operations where the computation problem is to reorder and sort the array elements which requires Θ(n logn) using comparison based sort.

The method may further comprise the steps of:
a) independently constructing two arrays, based on two randomly chosen polynomials;
b) XORing bitwise the free coefficients of the polynomials that generated, thereby serving each polynomial free coefficient, or success criteria, as a one-time pad for the other free coefficient, or success criteria; and
c) shuffling together the elements of the two arrays, to form a joint permutation.

The method may further comprise the step of hiding the coefficients using Rivest’s Rotated XOR operations between part or all of the coefficients of each, of several shuffled arrays, with success criteria that reside in the leaves of a Merkle binary tree, using Rivest Rotated XOR operation in each node of the Merkle tree, until reaching the Merkle tree root, which is regarded as the combined success criteria.

Whenever there are several sorted arrays, the free coefficients of their corresponding polynomials may be masked by:
a) taking the random permutation of the first array and applying it on the bits of the free coefficient of the polynomial that corresponds to the second array;
b) applying the permutation of the second array on the free coefficient of the polynomial that corresponds to the third array;
c) repeating the preceding step until the permutation of the last array is applied on the free coefficient of the polynomial that corresponds to the first array; and
d) performing Rivest’s Rotated XOR operations between all permuted success criteria.

The combined computation tasks may serve as Merkle puzzles for creating a symmetric key.

The symmetric key may define permutations used by a sender of a message to be sent, to shuffle the elements in the computation tasks, while XORing the combined success criterion with the message, to obtain an encrypted message.

The sent message may be revealed by the receiver by:
a) reordering the shuffled elements knowing the permutation;
b) computing the combined success criteria;
c) XORing the combined success criteria with the encrypted message.

The randomization used to create the elements by the sender may be revealed by the receiver and used to update the symmetric key.

A cryptosystem for creating a one-way function from a computation problem instances with a predefined success criteria, based on mutual hiding of the success criteria, comprising at lease one processor adapted to:
a) select at least a first and a second original computation tasks, each having an original corresponding success criterion;
b) apply a function over both original corresponding success criteria, to form a single combined success criterion for a mutual computation task being a combination of the at least a first and a second original computation tasks; and
c) output the original computation tasks along with the combined success criterion, while excluding the original corresponding success criteria.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 is a flowchart of the process proposed by the present invention.

### DETAILED DESCRIPTION OF THE INVENTION

The present invention also provides a method for creating a one-way function from a computation problem instances with a predefined success criteria, based on mutual hiding of the success criteria.

The present invention also provides a cryptosystem (a cryptosystem is a suite of cryptographic algorithms needed to implement a particular security service, for achieving confidentiality), based on permutations of random polynomial values (a permutation of an array of values is an arrangement of the array elements into a sequence or linear order, or if the array is already ordered, a rearrangement of its elements. For example, there are six permutations of the array {1,2,3}, namely: (1,2,3), (1,3,2), (2,1,3), (2,3,1), (3,1,2), and (3,2,1). These are all the possible orderings of this three-element array).

Sorting algorithms output in fact a permutation that when applied to the array variables the order of the array entries obtained is a nondecreasing order. A randomly shuffled array will require Θ(nlogn) comparison operations to resort the array.

The present invention provides an example of the existence of a provable one-way function, in the scope of fine-grained cryptography (a cryptographic primitive is a low-level algorithm used as the most basic building block to build cryptographic protocols for a security system. Fine-grained cryptographic primitives are secure against adversaries with an a-priori bounded polynomial amount of resources, such as time, space or parallel-time), in which both directions are polynomial. According to the present invention, given a sorted array, it takes only Θ(n) operations to randomly permute the array values uniformly over the permutation space.

In contrast, comparison-based sorting (a sorting algorithm is an algorithm that puts elements of a list in a certain order, such as (non) increasing or (non) decreasing. When any type of list or array is sorted, each time one element is compared to another element on the list, and after that, elements can be swapped) of the permuted array (of large enough number of values) requires, in the worst case, or an average case, Θ(nlogn) > Θ(n) compare operations. A comparison-based sorting algorithm takes as input an array [a₀, a₁, . . ., aₙ₋₁] of n items, and gains information about the items by comparing pairs of them. Each comparison (aᵢ >aⱼ ?) returns YES or NO and counts a 1 time-step. The algorithm may also be for free reorder items based on the results of comparisons made. In the end, the algorithm outputs a permutation of the input in which all items are in sorted order.

Some encryption techniques can be based on randomly shuffling a created sorted array, as a means for creating a one-way function. The following description specifies the one-way path from the creation of a sorted array to (uniformly) unsorted array and the reverse way, to obtain the sorted array.

The lower bound of comparison-based sorting is a basic result in computer science, which indicates how much time it takes to sort an array [a₀, a₁, . . ., aₙ₋₁] of n items (elements). The number of possible permutations of the inputs [a₀, a₁, . . ., aₙ₋₁] is n!, the number of decision binary tree leaves is log (n!) which is larger than log(n/2)^{n/2} which is equal to

$$\frac{n}{2} log \left(n / 2\right) = Ω \left(n log n\right) .$$

Shuffling a sorted array can be performed by Fisher-Yates shuffle (an algorithm for generating a random permutation of a finite sequence) for creating a randomized permutation permutations are the result of shuffling the sorted array using Fisher-Yates shuffle. For example, such an array may be of size n that consists of elements that are a power of two.

At the first step, each entry is considered as in Fisher-Yates shuffle, when dealing with the i′th item and receiving a random index j of log n of the size of the random bits of the array. At the next step, the process examines whether j < i and if j < i, the random index j discarded and another index j′ is received, until j′ is greater than i - 1. At the next step, a swap is performed and the index i is incremented by 1.

The sorted array of n elements is created using random incremental additions from element i to the i+1 element, in Θ(n) operations. Then the array is randomly shuffled in Θ(n) operations. The computation problem is to reorder and sort the array elements which requires Θ(n logn) using comparison based sorting.

In one embodiment, two arrays are Independently constructed, based on two randomly chosen polynomials, by bitwise XORing the free coefficients of the polynomials that were generated. By doing so, each polynomial free coefficient, or success criteria, serve as a one-time pad for the other free coefficient, or the other success criteria. The elements of the two arrays are shuffled together, to form a joint permutation.

Once i > n/2, the same process is used while considering only the second half of the array. This allows using one less bit of a random index related to the last half of the array, and so forth until the remainder of the array is of size two and only one random bit is used. The above procedure yields Θ(n) operations for producing a shuffled array chosen uniformly over all permutation possibilities.

The average depth of a leaf in a binary tree with n! leaves is Θ(nlogn). Therefore, with very high probability sorting, uniformly random chosen instances of a shuffled array are as hard as the worst case (the importance of average-case hardness as the Shortest Vector Problem (this problem is to find the non-zero shortest vector in lattice) over lattices (lattice problems are a class of optimization problems related to mathematical objects called lattices, where a lattice is the set of all integer linear combinations of basis vectors) and the permanent are demonstrated when implementing Merkle puzzles schemes (Key-agreement Protocol that protocol allows any two parties to create a shared secret key. The secret key can be later used to protect their further communication, protected by symmetric encryption), which are discussed, for example, in [5, 4]). The combined computation tasks serve as Merkle puzzles for creating a symmetric encryption key.

The computation ratio between the one-way to the reverse way is logarithmic as specified in [6].

There are Θ(n) sorts that are not comparison-based, such as counting sort (counting sort works by iterating through the input, counting the number of times each item occurs, and using those counts to compute an item’s index in the final sorted array) or Radix sort (a non-comparative sorting algorithm that avoids the need for comparisons by creating and distributing elements into buckets according to their radix. For elements with more than one significant digit, this bucketing process is repeated for each digit, while preserving the ordering of the prior step, until all digits have been considered). These sorts are based on a limited range of the array values and are less in use with respect to comparison-based sorting, possibly because computer architecture and the nature of input arrays make the comparison based more efficient in practice.

According to an embodiment of the invention, secret permutations are used to further increase the gap in the computation of the one-way versus the computation in the reverse way. Since the number of possible permutations is exponential with n, choosing an arbitrary random permutation rather than the sorted permutation as the secret may yield a greater gap in the computation of the one-way versus the computation in the reverse way (direction), which further increases the safety of a cryptosystem.

A permutation of n values may be described by a polynomial p of degree n - 1, where the x of a value in the array is the index in the array, and the y is the actual value. This gives n points [a₀, a₁, ..., aₙ₋₁] which are the y values of the polynomial that correspond to the indexes x, such that:

$$p \left(x\right) = {m}_{\text{n} - 1} {x}^{n - 1} + {m}_{\text{n} - 2} {x}^{n - 2} + … .. + {m}_{0}$$

According to one embodiment, the one-way function may be created by creating a sorted array of n distinct elements. The elements of the sorted array are represented by values y of a polynomial p of degree n - 1. The x of a value in the sorted array is the index of each element and the y is the actual value of the each element, where the coefficients of the polynomial are randomly chosen.

A plurality of randomized permutations of the sorted array are generated by swapping the first element in the sorted array with itself or with any other element and then swapping the second element in the obtained array with any other element in the obtained array with an element residing in a range that starts with the second element and ends with the last element. This process is repeated, until the element that currently resides in the array, with an index which is one prior to the last index is considered, for swapping with itself or with the element that currently has the very last index. Finally, the shuffled array is presented as a sorting computation task. If n points of the polynomial are known, then it is possible to reconstruct p.

It is possible to choose a polynomial p of degree n - 1 over a finite field, and use the free coefficient (as done in secret sharing), such that n points on the polynomial are needed to reveal the free coefficient (the secret). Then the values of the array can be calculated, according to the randomly chosen polynomial p.

The obtained array can be randomly permuted, while requiring a re-ordered array to fit a polynomial with the free coefficient as of the randomly chosen polynomial p. Since the free coefficient (the secret) is not revealed, it will be impossible to reconstruct the sorted array.

According to a further embodiment, in order to consider many permutations (or preferably, consider the number, being exponential with n, of all possible permutations) and avoid information leakage on the free coefficient, two such arrays [a₀, a₁, . . ., aₙ₋₁] and [b₀, b₁, ..., bₙ₋₁] can be independently constructed, based on two randomly chosen polynomials. Since the free coefficients of the polynomials that generated the two arrays are randomly selected and independent from each other, they can then be XORed bitwise, serving as a one-time pad (an encryption technique that cannot be cracked, but requires the use of a single-use pre-shared key that is no smaller than the message being sent) for each other. It is well known in cryptography that if a number (an element in the array) is XORed with a random value, the result carries no information and behaves like white noise. Therefore, the XOR operation is irreversible. As a result, the free coefficient is hidden by the white noise resulting from the XOR operation.

It is possible to use m > 1 instances of such arrays and bitwise XOR their free coefficients, to mask the value of any (randomly chosen) free coefficient with m - 1 other randomly chosen free coefficients. Then, the elements of the two arrays are shuffled together to form a permutation of m · n elements, or of n elements, if each array consists of n/m elements that are defined by a random polynomial of degree n/m - 1.

In an array of n elements, there are n! possible permutations. Each permutation may be identified by an identifier (a “name”), which in case of a polynomial representation, can be the free coefficient. However, there may be some permutations with the same free coefficient and also, some free coefficient values may extradite the permutation (for example, if the free coefficient is zero).

According to one embodiment, each array is represented by a polynomial with randomly selected coefficients, including the free coefficient. Each array has a “target value”, or success criteria, that defines the association between the order of the selected elements and is hidden by shuffling using random permutations. Therefore, even if all the permuted elements and the target value, namely the free coefficient, are revealed, it will most probably be very hard to reorder the elements to imply the target value.

### Mutual Hiding of Success Criteria

According to another embodiment, hiding the target value is obtained by selecting two arrays and XORing them (bitwise). Since the values of the free coefficients of each array are randomly selected, the XOR result will also be random.

At the first step, a target value is defined for each array. Such a target value may be the free coefficient in case the array is represented by a polynomial with randomly selected coefficients, or a subset-sum that is a result of adding (selected) elements (and performing a modular arithmetic operation on the sum) from the array to each other. For example, a target value of 772 may be a success criterion. In this case, the goal is to find a subset of elements from an array, such that the addition of then will be equal to 772 (possibly, mod modular arithmetic operation on some predefined value). If such a subset is found, it is defined as success. Similarly, in case of a polynomial with randomly selected coefficients, if the value of the free coefficient is obtained, it is also a success criterion. Therefore, in order to meet a success criterion, the goal is to re-permute the permuted array, or to select a subset of elements, the sum of which yields the target value.

The subset-sum can be defined by creating an array of random elements and summing a prefix of the array (performing a modular arithmetic operation) to serve as the success criteria and then randomly permuting the elements, once the elements are reordered the search for the chosen prefix is polynomial.

At the second step, hiding the success criteria is obtained by performing a bitwise XOR operation between these success criteria. Alternatively, hiding the success criteria may be obtained by shuffling the bits of the success criterion of the first array according to a selected permutation of the second array and then, shuffling the bits of the success criterion of the second array according to a selected permutation of the first array. Then, performing bitwise XOR operations between the shuffled bits of the success criteria. As a result, each bit in a success criterion of an array also depends on the order of the elements in the other array. In addition, hiding the success criteria of an array may be performed by shuffling the bits of the success criterion of the first array according to selected permutations of two or more different arrays.

According to another embodiment, hiding the success criteria of an array may be performed by shuffling the bits of the success criterion of the first array according to the indices of the elements in the selected subset sums of two or more different arrays.

For example, in order to hide the coefficients, it is possible to perform Rivest’s Rotated XOR operations between part or all of the free coefficients of the polynomial (i.e., the success criteria) of each, until reaching the Merkle tree root.

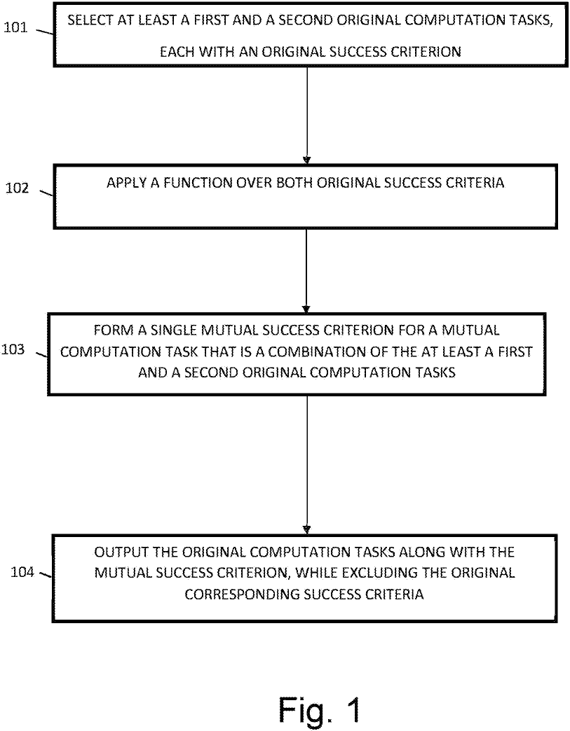

FIG. 1 is a flowchart of the process The present invention also provides a method for creating a one-way function from a computation problem instances with a predefined success criteria, based on mutual hiding of the success criteria. At the first step 101, a first and a second original computation tasks (at least) are selected, each with an original success criterion. At the next step 102, a function (such as a bitwise XOR) is applied over both original success criteria. At the next step 103, a single combined success criterion is formed for a mutual computation task that is a combination of the at least a first and a second original computation tasks. At the next step 104, the original computation tasks is output, along with the combined success criterion, while excluding the original corresponding success criteria.

According to an embodiment of the invention, the computation task is defined by elements in an array that represent a polynomial with randomly selected coefficients. In this case, the predefined success criteria is the free coefficient of the polynomial. The computation task consists of the success criteria and the elements of the array, which are randomly shuffled.

According to a further embodiment, if there are several sorted arrays, the free coefficients (i.e., the success criteria) of their corresponding polynomials are masked by taking the random permutation of the first array and applying it on the bits of the free coefficient of the polynomial that corresponds to the second array. Then the permutation of the second array is applied on the free coefficient of the polynomial that corresponds to the third array. This process goes on until the permutation of the last array is applied on the free coefficient of the polynomial that corresponds to the first array. Then, Rivest’s Rotated XOR operations between all permuted success criteria are performed. At this point, it will be impossible to reconstruct any of the sorted arrays by itself.

Another embodiment is based on using k (k > 2), independent arrays that define free coefficients of the polynomials, defined by the arrays F₁(0), F₂(0), ..., Fₖ(0) and Merkle’s tree root [8], where
the i′th leaf in the tree is F̅ᵢ(0) = (Fᵢ(0) » j₁) ⊕ (Fᵢ(0) »j₂);
j₁ and j₂ are two distinct values in the range 1 to b;
b is the number of bits in the field.

The parent of two leaves F̅₂ᵢ(0) and F̅₂ᵢ₊₁(0) is F̅₂ᵢ(0) ⊕ F̅₂ᵢ₊₁(0). The tree structure is recursively defined considering the new parent as a leaf of a tree of one less height.

Given the non-invertibility of each of the two versions of each F̅ᵢ(0) (See [9]), the resulting Merkle tree (also called a tree of hashes - is a tree in which every leaf node is labeled with the cryptographic hash of a data block, and every non-leaf node is labeled with the cryptographic hash of the labels of its child nodes. A Merkle tree is a structure used to efficiently verify the integrity of data in a set) root can fit an exponential number of trees with different leaves.

Also, it is possible to build a symmetric key cryptosystem, where the random shuffling permutation is the shared key, and the message is XORed bitwise with the two (or more) free coefficients (i.e., combined success criteria), thereby coping with leakage of a free coefficient in case of a known-plaintext attack.

The symmetric key defines permutations that are used by a sender of a message to be sent to a receiver, to shuffle the elements in the computation tasks. This is done while XORing the combined success criterion with the message, so as to obtain an encrypted message. The sent message is revealed by the receiver by reordering the shuffled elements (knowing the permutation), computing the combined success criteria, and finally, XORing the combined success criteria with the encrypted message. The randomization used to create the elements by the sender is revealed by the receiver and used to update the symmetric key.

The permutation secret key can be coordinately replaced even in every communication, by using the randomness of the polynomials.

It may be feasible to prove that there is a super polynomial computation gap between the two directions of computing of the suggested one-way functions, under (reasonable) computation model restriction as suggested for example, in [11], or under the computation time limitation as suggested for example, in [7].

According to an embodiment of the invention, mutual encoding of the success criteria is obtained using a balanced Merkle tree (a balanced Merkle tree is a balanced approach to build the tree of hashes, since keeping a balanced tree of hashes ensures fewer nodes count between the root and any element even in the worst possible case, so that makes a proof shorter) of Rivest’s Rotated XORs (Rivest suggested using data-dependent rotations before a word or a message is XORed bitwise, as a source of cryptographic strength. Accordingly, one word of intermediate results is cyclically rotated by an amount determined by the low-order bits of another intermediate result -see [9]).

The new proposed one-way function Q uses several independent inputs to define outputs of F₁(0), F₂(0), ..., Fₗ(0) and to replace F₁(0), F₂(0), ..., Fₗ(0) in the output by a Merkle tree root (a Merkle root is the hash of all the hashes of all the transactions that are part of a block in a blockchain network) [8] where the i′th leaf in the Merkle tree is F̅ᵢ(0) = (Fᵢ(0) » j₁) ⊕ (Fᵢ(0) »j₂) where j₁ and j₂ are two distinct values in the range 1 to b. The parent of two leaves F̅₂ᵢ(0) and F̅₂ᵢ₊₁(0) is F̅₂ᵢ(0) ⊕ F̅₂ᵢ₊₁(0). The Merkle tree structure is recursively defined considering the new parent as a leaf of a tree of one less height.

Given the non-invertibility of each of the two versions of each F̅ᵢ(0) (See [9]), the resulting Merkle tree root can fit an exponential number of trees with different leaves, where, for example, p³ >2^{b} ≥ p².

A logarithmic depth Merkle tree may require coping with only a logarithmic number of Rivest’s rotated XOR one-way functions, in order to reach a leaf. An unbalanced Merkle tree may require coping with a linear number of Rivest’s rotated XOR one-way function, for at least one leaf in the Merkle tree.

The coefficients are hidden using Rivest’s Rotated XOR operations between part or all of the coefficients of each of several shuffled arrays with success criteria that reside in the leaves of a Merkle binary tree. The Rivest Rotated XOR operation is performed in each node of the Merkle tree, until reaching the Merkle tree root. The root is regarded as the combined success criteria.

According to an embodiment of the invention, a Chain of Merkle Tree of Rivest’s Rotated XORs is implemented. The need to cope with n one way rotated XORs implies 2ⁿ⁻¹ possibilities of inputs to the XORs prior to examining the farthest from the root rotated XOR, enforces (under reasonable assumptions) a super-polynomial search of permutations in the arrays.

According to an embodiment of the invention, the success criteria may be encoded by mutual solutions. In order to encode, the bits of the free coefficient of the i + 1′th polynomial are permuted according to the solution of the i′th polynomial reordering solution (in case i + 1 > l, then i + 1 is replaced with 1). Then, all the permuted free coefficients are bit-wise XORed. In order to check the success criteria, there is a need to find the permutations. This implies the need to randomly guess permutations, since the value of the success criteria is totally random, even if one XORed element act as a one-time pad (seems so, then exponential time). The Rivest’s rotated XOR is used for each permuted success criteria, prior to XORing, thereby ensuring provable one-way function primitives, during the computation of the encoded success criteria.

It is believed that the approach in which a random function is used for one way, implying the need to cancel the randomization effect is a promising direction for provable one-way function also for higher complexity classes.

The method provided by the present invention may be used by cryptosystem for creating a one-way function from a computation problem instances with a predefined success criteria, based on mutual hiding of the success criteria. The cryptosystem comprises at lease one processor adapted to:
a) select at least a first and a second original computation tasks, each having an original corresponding success criterion;
b) apply a function over both original corresponding success criteria, to form a single combined success criterion for a mutual computation task being a combination of the at least a first and a second original computation tasks; and
c) output the original computation tasks along with the combined success criterion, while excluding the original corresponding success criteria.

The above examples and description have of course been provided only for the purpose of illustrations, and are not intended to limit the invention in any way. As will be appreciated by the skilled person, the invention can be carried out in a great variety of ways, employing more than one technique from those described above, all without exceeding the scope of the invention.

### REFERENCES

Alfred V Aho, John E Hopcroft, Jeffrey D Ullman, The Design and Analysis of Computer Algorithms, 1974.

Shlomi Dolev, Nova Fandina, Dan Gutfreund, “Succinct Permanent Is NEXP-Hard with Many Hard Instances”, CIAC 2013: 183-196.

Shlomi Dolev, Nova Fandina, Ximing Li, “Nested Merkle’s Puzzles against Sampling Attacks” Inscrypt 2012: 157-174.

Shlomi Dolev, Ephraim Korach, Ximing Li, Yin Li, Galit Uzan, “Magnifying computing gaps: Establishing encrypted communication over unidirectional channels,” Theor. Comput. Sci. 636: 17-26 (2016).

Akshay Degwekar, Vinod Vaikuntanathan, Prashant Nalini Vasudevan: “Fine-grained Cryptography.” IACR Cryptol. ePrint Arch. 580 2016.

Mrinal Kumar and Ramprasad Saptharishi, “An exponential lower bound for homogeneous depth-5 circuits over finite fields,” Proceedings of the 32nd Computational Complexity Conference, July 2017 Pages 130″€ℷ.

Ralph Merkle, “Secrecy, authentication and public key systems/A certified digital signature” Ph.D. dissertation, Dept. of Electrical Engineering, Stanford University, 1979.

Ron Rivest, “On the invertibility of the XOR rotations of a binary word,” International Journal of Computer Mathematics, 88.2, 1-4, 2011.

Adi Shamir, “A Polynomial-Time Algorithm for Breaking the Basic Merkle-Hellman Cryptosystem,” IEEE Transaction on Information Theory, Vol, IT-30, No. 5, 1984.

Victor Shoup and Roman Smolensky, “Lower bounds for polynomial evaluation and interpolation problems,” computational complexity, volume 6, pages 301311″€ℷ (1996).

Prashant Nalini Vasudevan, Fine-grained cryptography, D.Sc. thesis Massachusetts Institute of Technology, Cambridge, USA, 2018.

1. A method for creating a one-way function from a computation problem instances with a predefined success criteria, based on mutual hiding of said success criteria, comprising:
a) selecting at least a first and a second original computation tasks, each having an original corresponding success criterion;
b) applying a function over both original corresponding success criteria, to form a single combined success criterion for a mutual computation task being a combination of said at least a first and a second original computation tasks; and
c) outputting said original computation tasks along with said combined success criterion, while excluding said original corresponding success criteria.

2. A method according to claim 1, wherein the applied function is a bitwise XOR operation.

3. A method according to claim 1, wherein the computation task is defined by elements in an array representing a polynomial having randomly selected coefficients, the predefined success criteria is the free coefficient of said polynomial, the computation task consists of the success criteria and the randomly shuffled elements of the array.

4. A method according to claim 1, wherein the predefined success criteria is a subset-sum of each array of elements.

5. A method for creating one-way function, comprising:
a) creating a sorted array of n distinct elements;
b) representing the elements of said sorted array by values of a polynomial p of degree n -1, where the x of a value in said sorted array is the index of each element and the y is the actual value of said each element, wherein the coefficients of said polynomial are randomly chosen;
c) generating a plurality of randomized permutations of said sorted array by:
c.1) swapping the first element in said sorted array with itself or with any other element;
c.2) swapping the second element in the obtained array with any other element in said obtained array with an element residing in the range starting with the second element and ending with the last element;
c.3) repeating the preceding step, until considering the element currently residing in the array and having an index being one prior to the last index, for swapping with itself, or with the element currently having the very last index; and
c.4) presenting the shuffled array as a sorting computation task.

6. A method according to claim 5, wherein permutations are the result of shuffling the sorted array using Fisher-Yates shuffle, by:
a) considering each entry is as in Fisher-Yates shuffle, when dealing with the i′th item and receiving a random index j of log n of the size of the random bits of the array;
b) examining whether j < i and if j < i, discarding the random index j and receiving another index j′, until j′ is greater than i - 1;
c) performing a swap and incrementing the index i is by 1; and
d) repeating the preceding steps until i = n - 1.

7. A method according to claim 5, wherein the sorted array of n elements is created using random incremental additions from element i to the i+1 element, in Θ(n) operations, then randomly shuffled in Θ(n) operations where the computation problem is to reorder and sort the array elements which requires Θ(n logn) using comparison based sort.

8. A method according to claim 3, further comprising:
a) independently constructing two arrays, based on two randomly chosen polynomials;
b) XORing bitwise the free coefficients of the polynomials that generated, thereby serving each polynomial free coefficient, or success criteria, as a one-time pad for the other free coefficient, or success criteria; and
c) shuffling together the elements of the two arrays, to form a joint permutation.

9. A method according to claim 1, further comprising hiding the coefficients using Rivest’s Rotated XOR operations between part or all of the coefficients of each, of several shuffled arrays, having success criteria that reside in the leaves of a Merkle binary tree, using Rivest Rotated XOR operation in each node of the Merkle tree, until reaching the Merkle tree root, being regarded as the combined success criteria.

10. A method according to claim 1, wherein whenever there are several sorted arrays, the free coefficients of their corresponding polynomials are masked by:
a) taking the random permutation of the first array and applying it on the bits of the free coefficient of the polynomial that corresponds to the second array;
b) applying the permutation of the second array on the free coefficient of the polynomial that corresponds to the third array;
c) repeating the preceding step until the permutation of the last array is applied on the free coefficient of the polynomial that corresponds to the first array; and
d) performing Rivest’s Rotated XOR operations between all permuted success criteria.

11. A method according to claim 1, wherein the combined computation tasks serve as Merkle puzzles for creating a symmetric key.

12. A method according to claim 12, wherein the symmetric key defines permutations used by a sender of a message to be sent, to shuffle the elements in the computation tasks, while XORing the combined success criterion with said message, to obtain an encrypted message.

13. A method according to claim 13, further comprising revealing the sent message by the receiver by:
a) reordering the shuffled elements knowing the permutation;
b) computing the combined success criteria;
c) XORing the combined success criteria with the encrypted message.

14. A method according to claim 13, wherein the randomization used to create the elements by the sender is revealed by the receiver and used to update the symmetric key.

15. A cryptosystem for creating a one-way function from a computation problem instances with a predefined success criteria, based on mutual hiding of said success criteria, comprising at lease one processor adapted to:
d) select at least a first and a second original computation tasks, each having an original corresponding success criterion;
e) apply a function over both original corresponding success criteria, to form a single combined success criterion for a mutual computation task being a combination of said at least a first and a second original computation tasks; and
f) output said original computation tasks along with said combined success criterion, while excluding said original corresponding success criteria.
